(19) United States
(12) Patent Application Publication
(10) Pub. No.: US 2026/0138070 A1
(43) Pub. Date: May 21, 2026

(54) AIR FILTER CLEANING DEVICE

(71) Applicant: John Schmidt, Edinburg, TX (US)

(72) Inventor: John Schmidt, Edinburg, TX (US)

(21) Appl. No.: 18/953,327

(22) Filed: Nov. 20, 2024

(51) Int. Cl. B01D 46/71; B01D 41/04

(52) U.S. Cl. CPC B01D 46/71; B01D 41/04

(57) ABSTRACT

An air filter cleaning device includes a platform and a disk rotatably attached to the platform. A plurality of grips is slidably integrated into the disk which can abut against an air filter which is placed on top of the disk for securing the air filter on the disk. An air conduit is fluidly coupled to a source of compressed air and the air conduit extends upwardly through the platform, the bearing, and the disk. An outlet conduit is fluidly coupled to the air conduit which is positioned in a vertical orientation with respect to the disk. The outlet conduit has a plurality of air holes to release the compressed air outwardly from the outlet conduit and onto the air filter thereby enabling the compressed air to blow particulate matter out of the air filter for cleaning the air filter.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to air filter devices and more particularly pertains to a new air filter device for employing compressed air to clean particulate matter from an air filter. The device includes a platform and a disk rotatably coupled to the platform and an air conduit that is fluidly coupled to a source of compressed air. The air conduit extends upwardly through the platform and the disk. The device includes an outlet conduit that is fluidly coupled to the air conduit and the outlet conduit is vertically oriented over the disk. The outlet conduit has a plurality of air holes extending through the outlet conduit to direct compressed air onto an air filter that is positioned on the disk for cleaning particulate matter from the air filter.

### (2) Description of Related Art Including Information Disclosed Under 37 CFR 1.97 and 1.98

The prior art relates to air filter devices including: a process of removing embedded particulates from an air cleaner that employs pulses of compressed air, produced by a fluidic oscillator, to blow the embedded particulates from the air cleaner; an air filter cleaner device that includes a closed cabinet for containing an air filter and a jet for blowing air through the air filter and a suction device for suctionally removing dust from the closed cabinet; a filter cleaning system which includes a disk and an air compressor mounted to the disk and a set of pulse nozzles which blow compressed air received from the air compressor through an air filter that is positioned on the disk to blow dust from the air filter. In no instance does the prior art disclose an air filter cleaning device that includes a platform and a disk rotatably attached to the platform and an air conduit which extends upwardly through the platform and the disk and an outlet conduit attached to the air conduit which blows compressed air through an air filter that is positioned on the disk as the air filter is rotated around the air conduit for cleaning the air filter.

### (h) BRIEF SUMMARY OF THE INVENTION

An embodiment of the disclosure meets the needs presented above by generally comprising a platform and a disk rotatably attached to the platform. A plurality of grips is slidably integrated into the disk which can abut against an air filter which is placed on top of the disk for securing the air filter on the disk. An air conduit is fluidly coupled to a source of compressed air and the air conduit extends upwardly through the platform, the bearing, and the disk. An outlet conduit is fluidly coupled to the air conduit which is positioned in a vertical orientation with respect to the disk. The outlet conduit has a plurality of air holes to release the compressed air outwardly from the outlet conduit and onto the air filter thereby enabling the compressed air to blow particulate matter out of the air filter for cleaning the air filter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a right side view of an air filter cleaning device according to an embodiment of the disclosure.

FIG. 2 is a back view of an embodiment of the disclosure.

FIG. 3 is a top view of an embodiment of the disclosure.

FIG. 4 is a right side cut-away view of an embodiment of the disclosure.

FIG. 5 is a cross sectional view taken along line 5-5 of FIG. 3 of an embodiment of the disclosure showing compressed air being blown through an air filter for cleaning the air filter.

FIG. 6 is a cross sectional view taken along line 6-6 of FIG. 5 of an embodiment of the disclosure.

### (j) DETAILED DESCRIPTION OF THE INVENTION

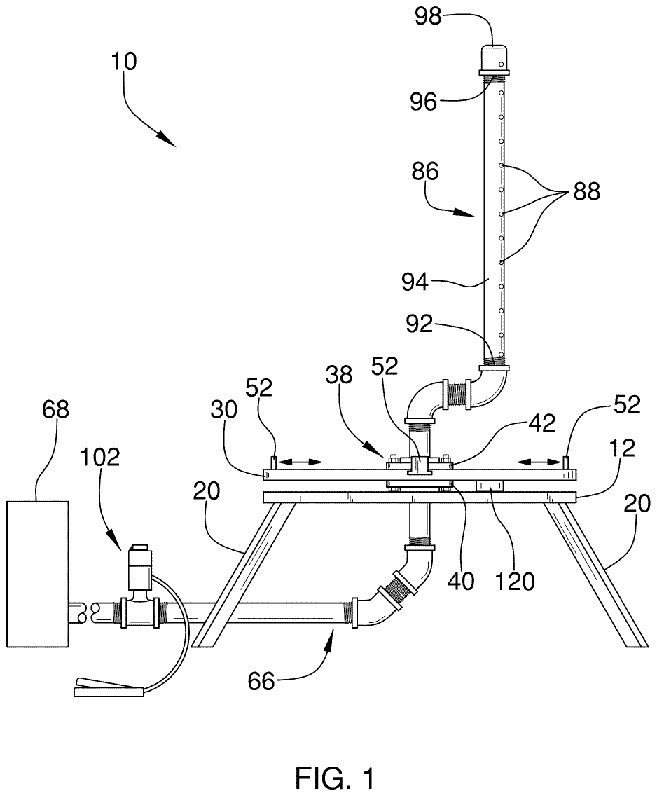

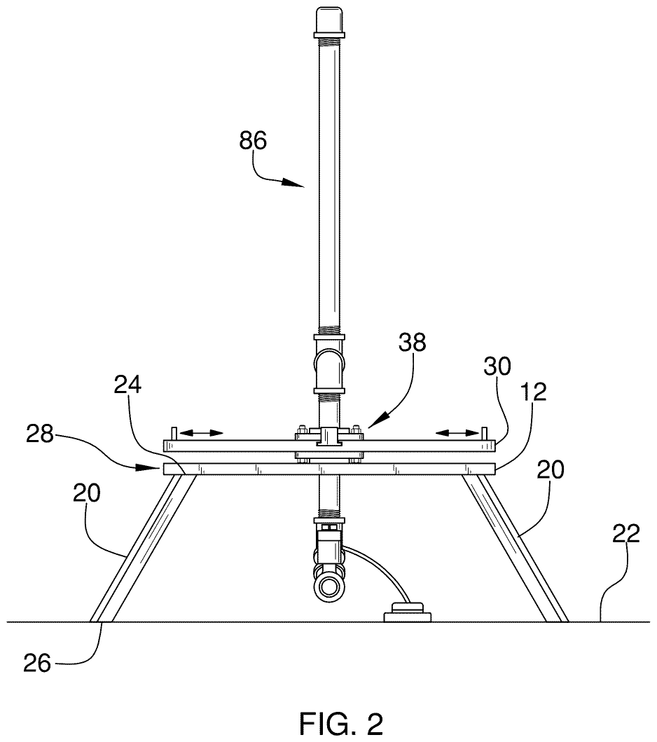

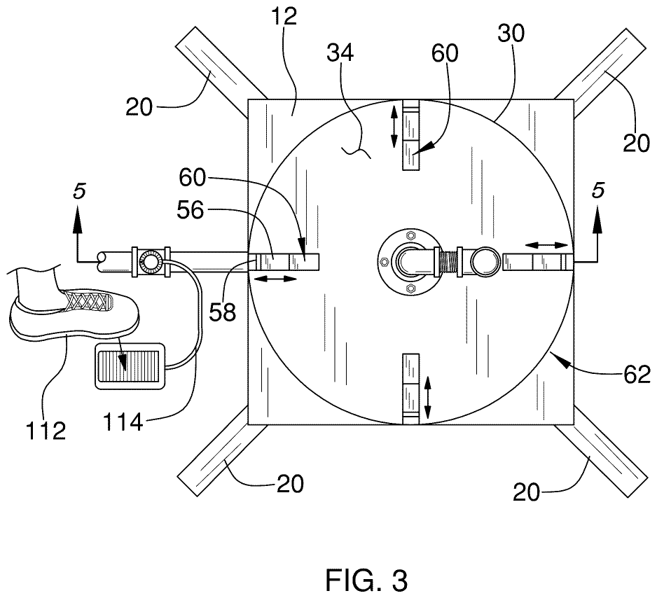

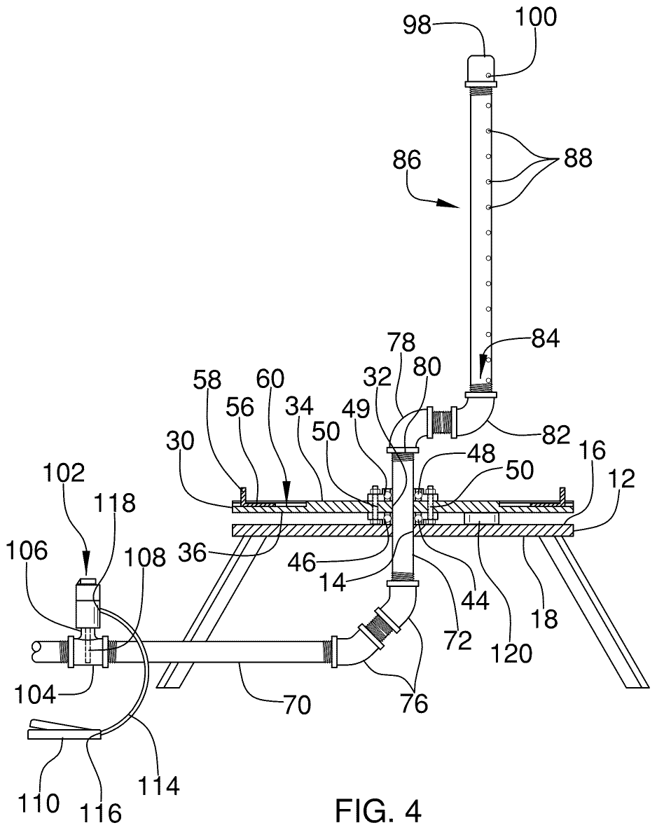

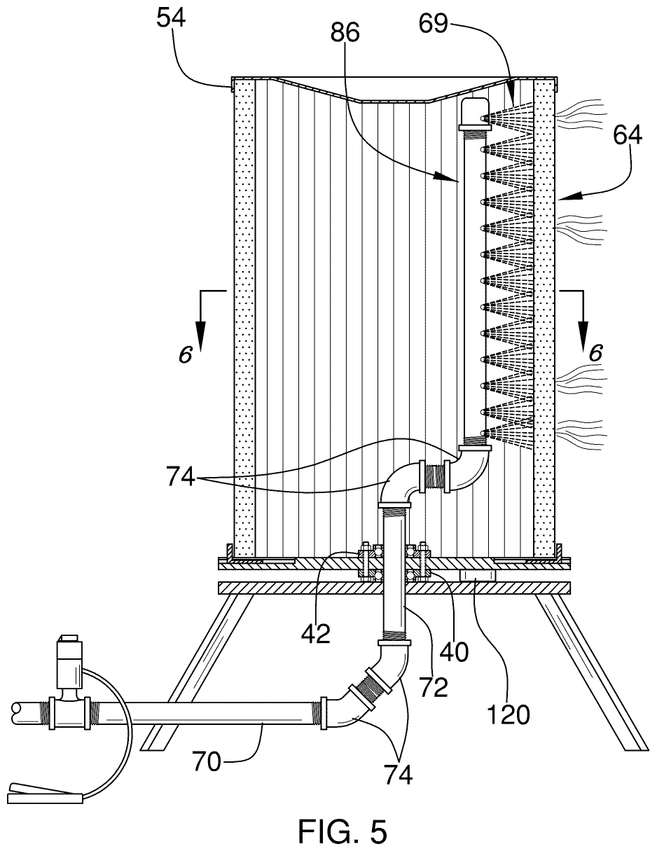

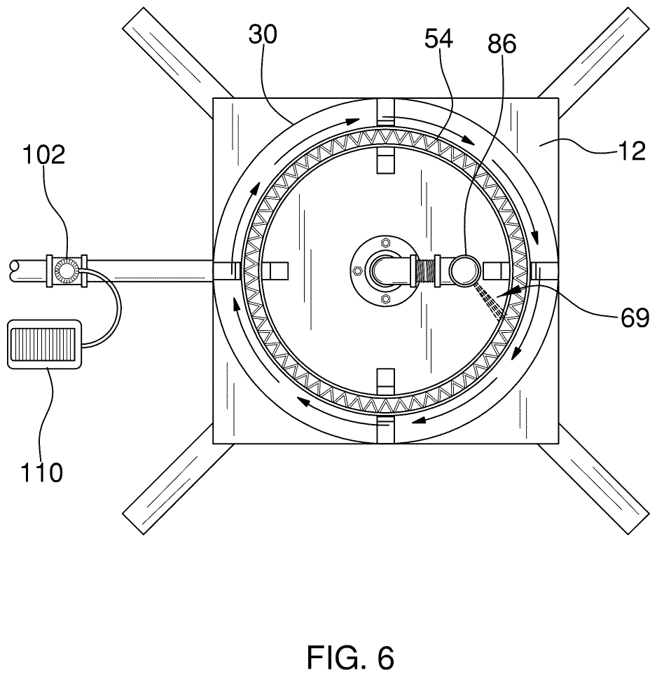

With reference now to the drawings, and in particular to FIGS. 1 through 6 thereof, a new air filter device embodying the principles and concepts of an embodiment of the disclosure and generally designated by the reference numeral 10 will be described.

As best illustrated in FIGS. 1 through 6, the air filter cleaning device 10 generally comprises a platform 12 which has a first hole 14 extending through a top surface 16 and a bottom surface 18 of the platform 12 and the first hole 14 is centrally located on the platform 12. A plurality of legs 20 is each coupled to the platform 12 to elevate the platform 12 above a horizontal support surface 22, which might be the ground or a floor of a building. Each leg 20 of the plurality of legs 20 has a top end 24 which is coupled to the bottom surface 18 of the platform 12 such that a bottom end 26 of each leg 20 of the plurality of legs 20 rests on the horizontal support surface 22. The top end 24 of each leg 20 of the plurality of legs 20 is spaced inwardly from an outer edge 28 of the platform 12 and the legs 20 are evenly spaced apart from each other and are distributed around a full circumference of the outer edge 28 of the platform 12. Furthermore, each leg 20 of the plurality of legs 20 is oriented to angle outwardly from the bottom surface 18 of the platform 12 to inhibit the platform 12 from tipping on the horizontal support surface 22.

A disk 30 is rotatably attached to the platform 12 having the disk 30 being spaced above the platform 12 such that the disk 30 lies on a plane which is oriented parallel to the platform 12. The disk 30 is rotatable about an axis which is perpendicularly oriented with the platform 12. The disk 30 has a second hole 32 extending through an upper surface 34 and a lower surface 36 of the disk 30. Additionally, the second hole 32 is centrally located on the disk 30 and the second hole 32 is aligned with the first hole 14 in the platform 12.

A bearing 38 is attached between the platform 12 and the disk 30 thereby enabling the disk 30 to be rotated on the platform 12. The bearing 38 includes a bottom annular ring 40 which is coupled to the lower surface 36 of the disk 30 such that the bottom annular ring 40 extends around the second hole 32 in the disk 30. The bearing 38 includes a top annular ring 42 which is attached to the upper surface 34 of the disk 30 such that the top annular ring 42 extends around the second hole 32 in the disk 30. The bearing 38 includes a first ball bearing 44 which is attached to the top surface 16 of the platform 12. The first ball bearing 44 is positioned in the bottom annular ring 40 having the first ball bearing 44 extending around a full circumference of an inwardly facing edge 46 of the bottom annular ring 40 such that the bottom annular ring 40 is rotatable around the first ball bearing 44. Furthermore, the first ball bearing 44 surrounds the first hole 14 in the platform 12.

The bearing 38 includes a second ball bearing 48 which is attached to the upper surface 34 of the disk 30. The second ball bearing 48 is positioned in the top annular ring 42 having the second ball bearing 48 extending around a full circumference of an inwardly facing edge 49 of the top annular ring 42 such that the top annular ring 42 is rotatable around the second ball bearing 48. Furthermore, the second ball bearing 48 surrounds the second hole 32 in the disk 30. Each of the first ball bearing 44 and the second ball bearing 48 may comprise friction reducing ball bearings of any conventional design that are greasable to enhance the service life of the first ball bearing 44 and the second ball bearing 48. The bearing 38 includes a plurality of fasteners 50 and each fastener 50 of the plurality of fasteners 50 extends through the top annular ring 42 and the bottom annular ring 40 having each fastener 50 of the plurality of fasteners 50 extending through the upper surface 34 of the disk 30 and the lower surface 36 of the disk 30. In this way the top annular ring 42 and the bottom annular ring 40 to rotate in conjunction with each other such that the disk 30 is rotatable on the platform 12. Furthermore, each fastener 50 of the plurality of fasteners 50 may comprise a nut and a bolt or other type of releasable mechanical fastener to enable the bearing 38 to be disassembled for service or replacement.

A plurality of grips 52 is provided and each grip 52 of the plurality of grips 52 is each slidably integrated into the disk 30. The grips 52 are evenly spaced apart from each other and are distributed around a full circumference of the disk 30. In this way each grip 52 of the plurality of grips 52 can abut against an air filter 54 which is placed on top of the disk 30 for securing the air filter 54 on the disk 30. The air filter 54 may comprise an air filter of any conventional design that is employed for filtering particulate matter 90 from air that flows through the air filter 54.

Each grip 52 of the plurality of grips 52 comprises a first section 56 which is perpendicularly oriented with a second section 58. The first section 56 of each grip 52 of the plurality of grips 52 is slidably positioned in a respective one of a plurality of channels 60 which is each recessed into the upper surface 34 of the disk 30 having the second section 58 of each grip 52 of the plurality of grips 52 extending upwardly from the upper surface 34 of the disk 30. Furthermore, each channel 60 of the plurality of channels 60 extends along a line which is perpendicularly oriented with an outer edge 62 of the disk 30 thereby enabling the second section 58 of each grip 52 of the plurality of grips 52 to abut against an outside surface 64 of the air filter 54.

An air conduit 66 is fluidly coupled to a source of compressed air 68 thereby enabling the air conduit 66 to receive compressed air 69 from the source of compressed air 68. The source of compressed air 68 may be a mechanical air compressor, an air tank filled with compressed air or any other source of compressed air. Additionally, the air conduit 66 extends upwardly through the platform 12 and the bearing 38 and the disk 30. The air conduit 66 comprises a first pipe 70 and a second pipe 72 and a plurality of elbows 74. A respective first pair of the plurality of elbows 76 is each coupled between the first pipe 70 and the second pipe 72 such that the first pipe 70 is oriented perpendicular to the second pipe 72. The first pipe 70 is positioned beneath the platform 12 having the first pipe 70 being oriented parallel to the platform 12 and the first pipe 70 is fluidly coupled to the source of compressed air 68. Furthermore, the second pipe 72 extends through the first hole 14 in the platform 12 and the bearing 38 and the second hole 32 in the disk 30.

A second one of the plurality of elbows 78 is fluidly coupled to an upper end 80 of the second pipe 72 such that the second elbow 78 is spaced upwardly from the upper surface 34 of the disk 30. A third one of the plurality of elbows 82 is fluidly coupled to the second elbow 78 such that the third elbow 82 defines an outlet 84 of the air conduit 66 which is directed upwardly with respect to the disk 30. Furthermore, the third elbow 82 is positioned between the bearing 38 and the outer edge 62 of the disk 30.

An outlet conduit 86 is fluidly coupled to the air conduit 66 thereby enabling the outlet conduit 86 to receive the compressed air 69 from the air conduit 66. The outlet conduit 86 is positioned above the disk 30 in a vertical orientation with respect to the disk 30. In this way the outlet conduit 86 extends upwardly along the air filter 54 when the air filter 54 is positioned on the disk 30. The outlet conduit 86 has a plurality of air holes 88 each extending through the outlet conduit 86 thereby enabling each air hole 88 of the plurality of air holes 88 to release the compressed air 69 outwardly from the outlet conduit 86 and onto the air filter 54. In this way the compressed air 69 can blow particulate matter 90 out of the air filter 54 for cleaning the air filter 54.

The outlet conduit 86 has a bottom end 92 of the outlet conduit 86 which is fluidly coupled to the outlet 84 of the air conduit 66 which is defined by the third elbow 82. Each air hole 88 of the plurality of air holes 88 extends through an outer wall 94 of the outlet conduit 86. Furthermore, the plurality of air holes 88 is evenly spaced apart from each other and is distributed along a full length of the outlet conduit 86. The outlet conduit 86 is oriented such that each air hole 88 of the plurality of air holes 88 is directed toward the outer edge 62 of the disk 30 thereby directing the compressed air 69 onto the air filter 54. Furthermore, the outlet conduit 86 has a top end 96 of the outlet conduit 86 which is closed to inhibit the compressed air 69 from escaping through the top end 96 of the outlet conduit 86. The top end 96 of the conduit may be closed with a cap 98, for example, and the cap 98 may have an air hole 100 extending through the cap 98 to enable the compressed air 69 to escape through the air hole 100 in the cap 98.

An air valve 102 is provided and the air valve 102 is fluidly integrated into the air conduit 66. The air valve 102 is actuatable into an open condition to enable the compressed air 69 to flow through the air conduit 66. Conversely, the air valve 102 is normally in a closed condition to inhibit the compressed air 69 from flowing through the air conduit 66. The air valve 102 includes a fitting 104 which is fluidly integrated into the first pipe 70 of the air conduit 66 and the fitting 104 has an outlet 106 upon which the air valve 102 is disposed. Furthermore, the air valve 102 may be a pneumatically controlled air valve of any conventional design, including but not being limited to a gate valve that might include a gate 108 which is positioned in the fitting 104 of the air valve 102 that opens or closes to either enable or inhibit the compressed air 69 to flow through the fitting 104.

A foot switch 110 is provided which is in operational communication with the air valve 102 and the foot switch 110 can be stepped upon by a user 112. The air valve 102 is actuated into the open condition when the foot switch 110 is stepped upon. Conversely, the air valve 102 is in the closed condition when the foot switch 110 is not stepped upon. The foot switch 110 may be a two position switch that is retained in an actuating condition when the foot switch 110 is initially stepped upon and which is retained in a de-actuating condition when the foot switch 110 is subsequently stepped upon. In this way the user 112 may not be required to continually step upon the foot switch 110 to actuate the air valve 102 into the open condition. A hose 114 is included which has a first end 116 that is fluidly coupled to the foot switch 110 and the hose 114 has a second end 118 which is fluidly coupled to the air valve 102. In this way the foot switch 110 is in fluid communication with the air valve 102 thereby enabling the foot switch 110 to control the air valve 102.

A rotation motor 120 may be provided and the rotation motor 120 may be attached between the platform 12 and the disk 30. The rotation motor 120 may rotate the disk 30 when the rotation motor 120 is turned on to enable the air filter 54 to be rotated around the outlet conduit 86. In this way the rotation motor 120 may enable the outlet conduit 86 to direct the compressed air 69 around a full circumference of the air filter 54 for completely removing the particulate matter 90 from the air filter 54. Thus, the user 112 does not have to monitor the air filter 54 while the compressed air 69 is being blown through the air filter 54 thereby protecting the user 112 from potentially inhaling the particulate matter 90 that is blown out of the air filter 54. Furthermore, the rotation motor 120 may comprise an electric motor which includes a drive system that is in mechanical communication with the disk 30. The drive system might include a series of gears, for example, to enable mechanical communication between the rotation motor 120 and the disk 30. Additionally, the rotation motor 120 might be in electrical communication with the foot switch 110 such that the rotation motor 120 is turned on when the foot switch 110 is initially stepped upon and the rotation motor 120 may be turned off when the foot switch 110 is subsequently stepped upon.

In use, the air filter 54 is positioned on top of the disk 30 and each of the grips 52 is manipulated to enable the second section 58 of each of the plurality of grips 52 to abut against the outside surface 64 of the air filter 54 to secure the air filter 54 to the disk 30. The user 112 steps upon the foot switch 110 to actuate the air valve 102 into the open condition to enable the compressed air 69 to be blown out of the outlet conduit 86 to pass through the air filter 54. In this way the compressed air 69 blows through the air filter 54 to remove the particulate matter 90 out of the air filter 54. Furthermore, the rotation motor 120 rotates the disk 30 thereby enabling the air filter 54 to be rotated around the outlet conduit 86 to enable the compressed air 69 to be blown through a full circumference of the air filter 54 for thoroughly cleaning the air filter 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An air filter cleaning device for removing particulate material from an air filter with compressed air, said device comprising:
a platform;
a plurality of legs, each of said plurality of legs being coupled to said platform wherein said plurality of legs is configured to elevate said platform above a horizontal support surface;
a disk being rotatably attached to said platform having said disk being spaced above said platform such that said disk lies on a plane being oriented parallel to said platform, said disk being rotatable about an axis being perpendicularly oriented with said platform;
a bearing being attached between said platform and said disk thereby enabling said disk to be rotated on said platform;
a plurality of grips, each grip of said plurality of grips being slidably integrated into said disk, said plurality of grips being evenly spaced apart from each other and being distributed around a full circumference of said disk wherein each of said plurality of grips is configured to abut against an air filter which is placed on top of said disk for securing the air filter on said disk;
an air conduit being configured to be fluidly coupled to a source of compressed air to receive compressed air from the source of compressed air, said air conduit extending upwardly through said platform and said bearing and said disk; and
an outlet conduit being fluidly coupled to said air conduit wherein said outlet conduit is configured to receive the compressed air from said air conduit, said outlet conduit being positioned above said disk in a vertical orientation with respect to said disk wherein said outlet conduit is configured to extend upwardly along the air filter when the air filter is positioned on said disk, said outlet conduit having a plurality of air holes each extending through said outlet conduit wherein each of said plurality of air holes is configured to release the compressed air outwardly from said outlet conduit and onto the air filter thereby enabling the compressed air to blow particulate matter out of the air filter for cleaning the air filter.

2. The air filter cleaning device according to claim 1, wherein:
each leg of said plurality of legs has a top end being coupled to a bottom surface of said platform wherein a bottom end of each of said plurality of legs is configured to rest on the horizontal support surface;
said top end of each leg of said plurality of legs is spaced inwardly from an outer edge of said platform;
each leg of said plurality of legs is evenly spaced apart from each other and is distributed around a full circumference of said outer edge of said platform; and
each leg of said plurality of legs is oriented to angle outwardly from said bottom surface of said platform wherein said plurality of legs is configured to inhibit said platform from tipping on the horizontal support surface.

3. The air filter cleaning device according to claim 1, wherein:
said platform has a first hole extending through a top surface and a bottom surface of said platform;
said first hole is centrally located on said platform;
said disk has a second hole extending through an upper surface and a lower surface of said disk;
said second hole is centrally located on said disk;
said second hole is aligned with said first hole in said platform.

4. The air filter cleaning device according to claim 3, wherein said bearing includes:
a bottom annular ring being coupled to said lower surface of said disk such that said bottom annular ring extends around said second hole in said disk;
a top annular ring being attached to said upper surface of said disk such that said top annular ring extends around said second hole in said disk.

5. The air filter cleaning device according to claim 4, wherein:
said bearing includes a first ball bearing being attached to said top surface of said platform;
said first ball bearing is positioned in said bottom annular ring having said first ball bearing extending around a full circumference of an inwardly facing edge of said bottom annular ring such that said bottom annular ring is rotatable around said first ball bearing; and
said first ball bearing surrounds said first hole in said platform.

6. The air filter cleaning device according to claim 5, wherein:
said bearing includes a second ball bearing being attached to said upper surface of said disk;
said second ball bearing is positioned in said top annular ring having said second ball bearing extending around a full circumference of an inwardly facing edge of said top annular ring such that said top annular ring is rotatable around said second ball bearing; and
said second ball bearing surrounds said second hole in said disk.

7. The air filter cleaning device according to claim 4, wherein:
said bearing includes a plurality of fasteners; and
each fastener of said plurality of fasteners extends through said top annular ring and said bottom annular ring having each of said plurality of fasteners extending through said upper surface of said disk and said lower surface of said disk thereby enabling said top annular ring and said bottom annular ring to rotate in conjunction with each other such that said disk is rotatable on said platform.

8. The air filter cleaning device according to claim 1, wherein:
said disk has an upper surface and an outer edge;
each of said plurality of grips comprises a first section being perpendicularly oriented with a second section; and
said first section of each of said plurality of grips is slidably positioned in a respective one of a plurality of channels which is each recessed into said upper surface of said disk having said second section of each of said plurality of grips extending upwardly from said upper surface of said disk.

9. The air filter cleaning device according to claim 8, wherein each channel of said plurality of channels extends along a line being perpendicularly oriented with an outer edge of said disk wherein said second section of each of said plurality of grips is configured to abut against an outside surface of the air filter.

10. The air filter cleaning device according to claim 1, wherein:
said air conduit comprises a first pipe and a second pipe and a plurality of elbows; and
a respective first pair of said plurality of elbows is each coupled between said first pipe and said second pipe such that said first pipe is oriented perpendicular to said second pipe.

11. The air filter cleaning device according to claim 10, wherein:
said first pipe is positioned beneath said platform having said first pipe being oriented parallel to said platform; and
said first pipe is fluidly coupled to said source of compressed air.

12. The air filter cleaning device according to claim 10, wherein:
said platform has a first hole extending through said platform;
said disk has a second hole extending through said disk; and
said second pipe extends through said first hole in said platform and said bearing and said second hole in said disk.

13. The air filter cleaning device according to claim 10, wherein:
a second one of said plurality of elbows is fluidly coupled to an upper end of said second pipe such that said second elbow is spaced upwardly from said upper surface of said disk;
a third one of said plurality of elbows is fluidly coupled to said second elbow such that said third elbow defines an outlet of said air conduit which is directed upwardly with respect to said disk; and
said third elbow is positioned between said bearing and an outer edge of said disk.

14. The air filter cleaning device according to claim 13, wherein:
said outlet conduit has a bottom end of said outlet conduit being fluidly coupled to said outlet of said air conduit which is defined by said third elbow; and
said outlet conduit has a top end of said outlet conduit being closed wherein said top end of said outlet conduit is configured to inhibit the compressed air from escaping through said top end of said outlet conduit;

15. The air filter cleaning device according to claim 1, wherein:
each air hole of said plurality of air holes extends through an outer wall of said outlet conduit;
each air hole of said plurality of air holes is evenly spaced apart from each other and is distributed along a full length of said outlet conduit; and
said outlet conduit is oriented such that each air hole of said plurality of air holes is directed toward an outer edge of said disk wherein said plurality of air holes is configured to direct the compressed air onto the air filter.

16. The air filter cleaning device according to claim 1, wherein:
said air filter cleaning device includes an air valve being fluidly integrated into said air conduit;
said air valve is actuatable into an open condition wherein said air valve is configured to enable the compressed air to flow through said air conduit;
said air valve is normally in a closed condition wherein said air valve is configured to inhibit the compressed air from flowing through said air conduit;
said air conduit includes a first pipe;
said air valve includes a fitting being fluidly integrated into said first pipe of said air conduit; and
said fitting has an outlet upon which said air valve is disposed.

17. The air filter cleaning device according to claim 16, wherein:
said air filter cleaning device includes a foot switch being in operational communication with said air valve wherein said foot switch is configured to be stepped upon by a user;
said air valve is actuated into said open condition when said foot switch is stepped upon;
said air valve is in said closed condition when said foot switch is not stepped upon;
said device includes a hose being having a first end being fluidly coupled to said foot switch; and
said hose has a second end being fluidly coupled to said air valve thereby enabling said foot switch to be in fluid communication with said air valve thereby enabling said foot switch to control said air valve.

18. The air filter cleaning device according to claim 1, wherein:
said air filter cleaning device includes a rotation motor being attached between said platform and said disk; and
said rotation motor rotates said disk when said rotation motor is turned on wherein said rotation motor is configured to enable the air filter to be rotated around said outlet conduit thereby enabling the outlet conduit to direct the compressed air around a full circumference of the air filter for completely removing the particulate matter from the air filter.

19. An air filter cleaning device for removing particulate material from an air filter with compressed air, said device comprising:
a platform, said platform having a first hole extending through a top surface and a bottom surface of said platform, said first hole being centrally located on said platform;
a plurality of legs, each leg of said plurality of legs being coupled to said platform wherein said plurality of legs is configured to elevate said platform above a horizontal support surface, each leg of said plurality of legs having a top end being coupled to said bottom surface of said platform wherein a bottom end of each leg of said plurality of legs is configured to rest on the horizontal support surface, said top end of each leg of said plurality of legs being spaced inwardly from an outer edge of said platform, said leg of said plurality of legs being evenly spaced apart from each other and being distributed around a full circumference of said outer edge of said platform, each leg of said plurality of legs being oriented to angle outwardly from said bottom surface of said platform wherein said plurality of legs is configured to inhibit said platform from tipping on the horizontal support surface;
a disk being rotatably attached to said platform having said disk being spaced above said platform such that said disk lies on a plane being oriented parallel to said platform, said disk being rotatable about an axis being perpendicularly oriented with said platform, said disk having a second hole extending through an upper surface and a lower surface of said disk, said second hole being centrally located on said disk, said second hole being aligned with said first hole in said platform;
a bearing being attached between said platform and said disk thereby enabling said disk to be rotated on said platform, said bearing comprising:
a bottom annular ring being coupled to said lower surface of said disk such that said bottom annular ring extends around said second hole in said disk;
a top annular ring being attached to said upper surface of said disk such that said top annular ring extends around said second hole in said disk;
a first ball bearing being attached to said top surface of said platform, said first ball bearing being positioned in said bottom annular ring having said first ball bearing extending around a full circumference of an inwardly facing edge of said bottom annular ring such that said bottom annular ring is rotatable around said first ball bearing, said first ball bearing surrounding said first hole in said platform;
a second ball bearing being attached to said upper surface of said disk, said second ball bearing being positioned in said top annular ring having said second ball bearing extending around a full circumference of an inwardly facing edge of said top annular ring such that said top annular ring is rotatable around said second ball bearing, said second ball bearing surrounding said second hole in said disk; and
a plurality of fasteners, each fastener of said plurality of fasteners extending through said top annular ring and said bottom annular ring having each fastener of said plurality of fasteners extending through said upper surface of said disk and said lower surface of said disk thereby enabling said top annular ring and said bottom annular ring to rotate in conjunction with each other such that said disk is rotatable on said platform;
a plurality of grips, each grip of said plurality of grips being slidably integrated into said disk, each grip of said plurality of grips being evenly spaced apart from each other and being distributed around a full circumference of said disk wherein each grip of said plurality of grips is configured to abut against an air filter which is placed on top of said disk for securing the air filter on said disk, each grip of said plurality of grips comprising a first section being perpendicularly oriented with a second section, said first section of each grip of said plurality of grips being slidably positioned in a respective one of a plurality of channels which is each recessed into said upper surface of said disk having said second section of each grip of said plurality of grips extending upwardly from said upper surface of said disk, each channel of said plurality of channels extending along a line being perpendicularly oriented with an outer edge of said disk wherein said second section of each grip of said plurality of grips is configured to abut against an outside surface of the air filter;
an air conduit being fluidly coupled to a source of compressed air wherein said air conduit is configured to receive compressed air from said source of compressed air, said air conduit extending upwardly through said platform and said bearing and said disk, said air conduit comprising a first pipe and a second pipe and a plurality of elbows, a respective first pair of said plurality of elbows each being coupled between said first pipe and said second pipe such that said first pipe is oriented perpendicular to said second pipe, said first pipe being positioned beneath said platform having said first pipe being oriented parallel to said platform, said first pipe being fluidly coupled to said source of compressed air, said second pipe extending through said first hole in said platform and said bearing and said second hole in said disk, a second one of said plurality of elbows being fluidly coupled to an upper end of said second pipe such that said second elbow is spaced upwardly from said upper surface of said disk, a third one of said plurality of elbows being fluidly coupled to said second elbow such that said third elbow defines an outlet of said air conduit which is directed upwardly with respect to said disk, said third elbow being positioned between said bearing and said outer edge of said disk;
an outlet conduit being fluidly coupled to said air conduit wherein said outlet conduit is configured to receive the compressed air from said air conduit, said outlet conduit being positioned above said disk in a vertical orientation with respect to said disk wherein said outlet conduit is configured to extend upwardly along the air filter when the air filter is positioned on said disk, said outlet conduit having a plurality of air holes each extending through said outlet conduit wherein each air hole of said plurality of air holes is configured to release the compressed air outwardly from said outlet conduit and onto the air filter thereby enabling the compressed air to blow particulate matter out of the air filter for cleaning the air filter, said outlet conduit having a bottom end of said outlet conduit being fluidly coupled to said outlet of said air conduit which is defined by said third elbow, each air hole of said plurality of air holes extending through an outer wall of said outlet conduit, each air hole of said plurality of air holes being evenly spaced apart from each other and being distributed along a full length of said outlet conduit, said outlet conduit being oriented such that each of said plurality of air holes is directed toward said outer edge of said disk wherein said plurality of air holes is configured to direct the compressed air onto the air filter, said outlet conduit having a top end of said outlet conduit being closed wherein said top end of said outlet conduit is configured to inhibit the compressed air from escaping through said top end of said outlet conduit;
an air valve being fluidly integrated into said air conduit, said air valve being actuatable into an open condition wherein said air valve is configured to enable the compressed air to flow through said air conduit, said air valve being normally in a closed condition wherein said air valve is configured to inhibit the compressed air from flowing through said air conduit, said air valve including a fitting being fluidly integrated into said first pipe of said air conduit, said fitting having an outlet upon which said air valve is disposed;
a foot switch being in operational communication with said air valve wherein said foot switch is configured to be stepped upon by a user, said air valve being actuated into said open condition when said foot switch is stepped upon, said air valve being in said closed condition when said foot switch is not stepped upon;
a hose being having a first end being fluidly coupled to said foot switch, said hose having a second end being fluidly coupled to said air valve thereby enabling said foot switch to be in fluid communication with said air valve thereby enabling said foot switch to control said air valve; and
a rotation motor being attached between said platform and said disk, said rotation motor rotating said disk when said rotation motor is turned on wherein said rotation motor is configured to enable the air filter to be rotated around said outlet conduit thereby enabling the outlet conduit to direct the compressed air around a full circumference of the air filter for completely removing the particulate matter from the air filter.
